(19) United States
(12) Patent Application Publication
(10) Pub. No.: US 2013/0168619 A1
(43) Pub. Date: Jul. 4, 2013

(54) Thermoplastic Resin Composition Having Excellent Flame Retardancy, Colorability and Thermal Stability

(71) Applicant: Cheil Industries Inc., Gumi-si (KR)

(72) Inventors: Jin Seong Lee, Suwon-si (KR); Kang Yeol Park, Yongin-si (KR); Seon Ae Lee, Bucheon-si (KR); Dong Hyun Park, Gunpo-si (KR); Gyeong Ha Chae, Seoul-si (KR); Yoen Kyoung Kim, Seoul-si (KR); Young Chul Kwon, Suwon-si (KR)

(73) Assignee: Cheil Industries Inc., Gumi-si (KR)

(21) Appl. No.: 13/728,154

(22) Filed: Dec. 27, 2012

(30) Foreign Application Priority Data
Dec. 30, 2011 (KR) 10-2011-0147438
Dec. 20, 2012 (KR) 10-2012-0149275

(51) Int. Cl. C09K 21/14

(52) U.S. Cl. CPC C09K 21/14
USPC 252/601

(57) ABSTRACT

A thermoplastic resin composition comprises (A) about 45 to about 95% by weight of an aromatic copolymer, (B) about 5 to about 55% by weight of a polycarbonate resin, (C) about 1 to about 30 parts by weight of a halogen-containing compound based on about 100 parts by weight of the aromatic copolymer (A) and the polycarbonate resin (B), and (D) about 0 to about 2 parts by weight of an antimony compound based on about 100 parts by weight of the aromatic copolymer (A) and the polycarbonate resin (B). The thermoplastic resin composition can have excellent flame retardancy, colorability and thermal stability.

### CROSS-REFERENCE TO RELATED APPLICATIONS

This application claims priority from Korea Patent Application Nos. 10-2011-0147438, filed on Dec. 30, 2011, and 10-2012-0149275, filed on Dec. 20, 2012, in the Korean Intellectual Property Office, the disclosure of which is incorporated herein by reference in its entirety.

### FIELD OF THE INVENTION

The present invention relates to a thermoplastic resin composition that can have excellent flame retardancy, colorability and thermal stability.

### BACKGROUND OF THE INVENTION

Generally, rubber modified styrene based copolymer resins can have good mechanical strength, processability, excellent impact strength and good appearance, and accordingly are widely used in the manufacture of electric and electronic goods. However, a rubber modified styrene based copolymer resin does not have combustion resistance and if it is ignited, the rubber modified styrene based copolymer resin may cause fire to spread.

Accordingly countries such as the United States, Japan and many European countries have passed laws requiring polymer resins to satisfy flame resistance standards to guarantee stability in the presence of a fire.

Various techniques can impart flame retardancy to polymers. For example, many conventionally used and well known flame retarding methods are adding flame retardants to polymer resins. These additive type flame retardants can be classified according to their components and include halogen-containing, phosphorus-containing, nitrogen-containing, silicone-containing, inorganic material-containing flame retardants, and the like.

A widely used method for imparting flame resistance to a rubber modified styrene based copolymer resin is to add a halogen-containing flame retardant and antimony compound to the resin. For example, one such method imparts flame retardancy to acrylonitrile-butadiene-styrene (ABS) resin or high impact polystyrene (HIPS) resin by adding a halogen containing flame retardant and an antimony compound in a weight ratio of about 2.5:1 to about 4:1.

When using an antimony trioxide as an antimony compound, the antimony trioxide which is a white inorganic material deteriorates colorability of the resin composition. In particular, it can be difficult to provide a black appearance to the end product. Also, using an antimony compound at high injection temperatures can generate discoloration and out-gas as a result of a reaction with the halogen-containing flame retardant.

When an antimony compound is not used, however, about 2 to 3 times the amount of a halogen-containing flame retardant is used, as compared to the amount of a halogen-containing flame retardant used in combination with the antimony compound. Accordingly, when using only the halogen-containing flame retardant, mechanical properties such as impact strength, tensile strength, flexural strength and the like and thermal properties such as heat resistance, heat distortion temperature, and the like of the resin composition can be deteriorated, thereby the use of such resin composition is limited in the manufacture of electric and electronic goods.

Another widely used method for imparting flame resistance to a rubber modified styrene based copolymer resin is to add an anti-dripping agent, which can help reduce the amount of an antimony compound required. Generally, the amount of an antimony compound required can be reduced by using a small amount of the anti-dripping agent, for example, about 0.05 to about 1 parts by weight of an anti-dripping agent based on 100 parts by weight of the resin composition. Polytetrafluoroethylene (PTFE) is typically used as the anti-dripping agent. The addition of an anti-dripping agent, however, does not eliminate the need for an antimony compound.

### SUMMARY OF THE INVENTION

The present invention provides a thermoplastic resin composition that can have good flame retardancy. The present invention also provides a thermoplastic resin composition that can have good colorability. The present invention further provides a thermoplastic resin composition that can have good thermal stability.

A thermoplastic resin composition of the present invention may comprise (A) about 45 to about 95% by weight of an aromatic copolymer, (B) about 5 to about 55% by weight of a polycarbonate resin, (C) about 1 to about 30 parts by weight of a halogen-containing compound based on about 100 parts by weight of the aromatic copolymer (A) and the polycarbonate resin (B), and (D) about 0 to about 2 parts by weight of an antimony compound based on about 100 parts by weight of the aromatic copolymer (A) and the polycarbonate resin (B).

The aromatic copolymer (A) may comprise (a1) a rubber modified aromatic vinyl based graft copolymer and (a2) an aromatic vinyl based copolymer. The rubber modified aromatic vinyl based graft copolymer (a1) can be used in an amount of about 10 to about 40% by weight based on about 100% by weight of the aromatic copolymer (A) and the polycarbonate resin (B). The aromatic vinyl based copolymer (a2) can be used in an amount of about 5 to about 85% by weight based on about 100% by weight of the aromatic copolymer (A) and the polycarbonate resin (B).

The rubber modified aromatic vinyl based graft copolymer (a1) may comprise about 5 to about 65% by weight of a rubbery polymer, about 20 to about 94% by weight of an aromatic vinyl monomer, and about 1 to about 40% by weight of a monomer copolymerizable with the aromatic vinyl monomer, based on the total weight (about 100% by weight) of the rubber modified aromatic vinyl based graft copolymer (a1).

The rubbery polymer may comprise a diene rubber, a saturated rubber in which hydrogen is added to a diene rubber, an acrylic rubber, an ethylene-propylene rubber, an ethylene-propylene-diene terpolymer (EPDM), a silicone rubber, or a combination thereof.

The aromatic vinyl monomer may comprise styrene, α-methyl styrene, β-methyl styrene, p-methyl styrene, p-(tert-butyl)styrene, ethylstyrene, vinylxylene, monochlorostyrene, dichlorostyrene, dibromostyrene, vinylnaphthalene, or a combination thereof.

The monomer copolymerizable with the aromatic vinyl monomer may comprise an unsaturated nitrile monomer, an acrylic monomer, or a combination thereof.

The aromatic vinyl based copolymer (a2) may comprise about 60 to about 90% by weight of an aromatic vinyl monomer, and about 10 to about 40% by weight of a monomer copolymerizable with the aromatic vinyl monomer, based on the total weight (about 100% by weight) of the aromatic vinyl based copolymer (a2).

The aromatic vinyl monomer may comprise styrene, α-methyl styrene, β-methyl styrene, p-methyl styrene, p-(tert-butyl)styrene, ethylstyrene, vinylxylene, monochlorostyrene, dichlorostyrene, dibromostyrene, vinylnaphthalene, or a combination thereof.

The monomer copolymerizable with the aromatic vinyl monomer may comprise an unsaturated nitrile monomer, an acrylic monomer, or a combination thereof.

The aromatic vinyl based copolymer (a2) may further comprise about 0 to about 30% by weight of a monomer comprising an unsaturated carboxylic acid, an unsaturated carboxylic anhydride, a maleimide monomer, or a combination thereof, based on about 100% by weight of the aromatic vinyl based copolymer (a2).

The polycarbonate resin (B) according to the present invention may have a weight average molecular weight (Mw) of about 10,000 to about 200,000 g/mol.

The polycarbonate resin (B) according to the present invention may be a bisphenol-A based polycarbonate.

The halogen-containing compound (C) may comprise decabromodiphenyl ethane, decabromodiphenyl ether, tetrabromobisphenol-A, tetrabromobisphenol-A epoxy oligomer, octabromotrimethylphenylindane, ethylene-bis-tetrabromophthalimide, tris(tribromophenol)triazine, brominated polystyrene, decabromodiphenyl oxide, or a combination thereof.

The halogen-containing compound (C) may comprise about 50 to about 90% by weight of halogen.

The antimony compound (D) may comprise an antimony trioxide, an antimony pentaoxide, or a combination thereof.

The thermoplastic resin composition may further comprise an additive comprising an impact modifier, an anti-dripping agent, an antioxidant, a plasticizer, a heat stabilizer, a light stabilizer, a compatibilizer, a weather resistant agent, a dye, a pigment, a coloring agent, an inorganic filler, or a combination thereof.

The thermoplastic resin composition of the present invention may have a flame retardancy measured in accordance with UL 94 using a specimen with a thickness of 1.5 mm of about V0.

The thermoplastic resin composition of the present invention may have a value of L measured in accordance with ASTM D1925 using a spectrophotometer of about 26 to about 27.

The thermoplastic resin composition of the invention may also have a number of burst marks for out-gas of about 0 to about 5 when subject to injection molding conditions, for example a cylinder temperature of about 250° C. and a residence time of about 10 minutes, as for 10 injection molded specimens.

The present invention also provides a thermoplastic molded article prepared using the thermoplastic resin composition of the present invention.

### DETAILED DESCRIPTION OF THE INVENTION

The present invention will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention relates to a thermoplastic resin composition that can have excellent flame retardancy, colorability and thermal stability.

The thermoplastic resin composition of the present invention may comprise (A) about 45 to about 95% by weight of an aromatic copolymer, (B) about 5 to about 55% by weight of a polycarbonate resin, (C) about 1 to about 30 parts by weight of a halogen-containing compound based on about 100 parts by weight of the aromatic copolymer (A) and the polycarbonate resin (B), and (D) about 0 to about 2 parts by weight of an antimony compound based on about 100 parts by weight of the aromatic copolymer (A) and the polycarbonate resin (B).

(A) Aromatic Copolymer

An aromatic copolymer (A) of the present invention can be a copolymer of an aromatic vinyl monomer and a monomer polymerizable with the aromatic vinyl monomer.

The thermoplastic resin composition may comprise the aromatic copolymer (A) in an amount of about 45 to about 95% by weight, based on about 100% by weight of the aromatic copolymer (A) and the polycarbonate resin (B). In some embodiments, the thermoplastic resin composition may include the aromatic copolymer (A) in an amount of about 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95% by weight. Further, according to some embodiments of the present invention, the aromatic copolymer (A) may be present in an amount of from about any of the foregoing amounts to about any other of the foregoing amounts.

The aromatic copolymer (A) may include (a1) a rubber modified aromatic vinyl based graft copolymer and (a2) an aromatic vinyl based copolymer.

The aromatic copolymer (A) may include the rubber modified aromatic vinyl based graft copolymer (a1) in an amount of about 10 to about 40% by weight based on about 100% by weight of the aromatic copolymer (A) and the polycarbonate resin (B). In some embodiments, the aromatic copolymer (A) may include the rubber modified aromatic vinyl based graft copolymer (a1) in an amount of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% by weight based on about 100% by weight of the aromatic copolymer (A) and the polycarbonate resin (B). Further, according to some embodiments of the present invention, the rubber modified aromatic vinyl based graft copolymer (a1) may be present in an amount of from about any of the foregoing amounts to about any other of the foregoing amounts.

The aromatic copolymer (A) may include the aromatic vinyl based copolymer (a2) in an amount of about 5 to about 85% by weight based on about 100% by weight of the aromatic copolymer (A) and the polycarbonate resin (B). In some embodiments, the aromatic copolymer (A) may include the aromatic vinyl based copolymer (a2) in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, or 85% by weight based on about 100% by weight of the aromatic copolymer (A) and the polycarbonate resin (B). Further, according to some embodiments of the present invention, the aromatic vinyl based copolymer (a2) may be present in an amount of from about any of the foregoing amounts to about any other of the foregoing amounts.

(a1) Rubber Modified Aromatic Vinyl Based Graft Copolymer

The rubber modified aromatic vinyl based graft copolymer (a1) can be prepared by copolymerizing a rubbery polymer, an aromatic vinyl monomer, optionally a monomer copolymerizable with the aromatic vinyl monomer, and optionally a monomer imparting processability and heat resistance.

The rubber modified aromatic vinyl based graft copolymer (a1) can include about 5 to about 65% by weight of the rubbery polymer, about 20 to about 94% by weight of the aromatic vinyl monomer, and about 1 to about 40% by weight of the monomer copolymerizable with the aromatic vinyl monomer, each based on the total weight (about 100% by weight) of the rubber modified aromatic vinyl based graft copolymer (a1).

Examples of the rubbery polymer suitable for preparing the graft copolymer resin may include without limitation diene rubbers, saturated rubbers in which hydrogen is added to a diene rubber, acrylic rubbers, ethylene-propylene rubbers, ethylene-propylene-diene terpolymers (EPDM), silicone rubbers, and the like, and combinations thereof.

Examples of the diene rubber include without limitation polybutadiene, poly(styrene-butadiene), poly(acrylonitrile-butadiene), polyisoprene, and the like, and combinations thereof.

Examples of the acrylic rubber include without limitation poly(methyl acrylate), poly(ethyl acrylate), poly(n-propyl acrylate), poly(n-butyl acrylate), poly(2-ethylhexyl acrylate), poly(hexyl methacrylate), poly(2-ethylhexyl methacrylate), and the like, and combinations thereof.

Examples of the silicone rubber include without limitation polyhexamethyl cyclotrisiloxane, polyoctamethyl cyclosiloxane, polydecamethyl cyclosiloxane, polydodecamethyl cyclosiloxane, polytrimethyltriphenyl cyclosiloxane, polytetramethyltetraphenyl cyclotetrasiloxane, polyoctaphenyl cyclotetrasiloxane, and the like, and combinations thereof.

Suitable rubbery polymer for use in the rubber modified aromatic vinyl based graft copolymer (a1) of the present invention may be the diene rubber, for example polybutadiene rubber.

The rubber modified aromatic vinyl based graft copolymer (a1) can include about 5 to about 65% by weight of the rubbery polymer, based on the total weight (about 100% by weight) of the rubber modified aromatic vinyl based graft copolymer (a1). In some embodiments, the rubber modified aromatic vinyl based graft copolymer (a1) may include the rubbery polymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65% by weight. Further, according to some embodiments of the present invention, the rubbery polymer may be present in an amount of from about any of the foregoing amounts to about any other of the foregoing amounts.

The Z-average particle size of the rubbery polymer in the rubber modified aromatic vinyl based graft copolymer can range from about 0.05 to 4.0 μm, for example about 0.1 to about 3.0 μm. When the Z-average particle size of the rubbery polymer is within the above range, impact strength and appearance of the thermoplastic resin composition of the present invention can be improved.

Examples of the aromatic vinyl monomer may include without limitation styrene monomers such as styrene, α-methyl styrene, β-methyl styrene, p-methyl styrene, p-(tert-butyl)styrene, ethylstyrene, monochlorostyrene, dichlorostyrene, dibromostyrene, vinylxylene, vinylnaphthalene and the like, and combinations thereof.

The aromatic vinyl monomer can be used in an amount of about 20 to about 94% by weight based on the total weight (about 100% by weight) of the rubber modified aromatic vinyl based graft copolymer (a1). In some embodiments, the rubber modified aromatic vinyl based graft copolymer (a1) may include the aromatic vinyl monomer in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, or 94% by weight. Further, according to some embodiments of the present invention, the aromatic vinyl monomer may be present in an amount of from about any of the foregoing amounts to about any other of the foregoing amounts.

One or more kind of monomers copolymerizable with the aromatic vinyl monomer may also be included. Examples of the monomer copolymerizable with the aromatic vinyl monomer may include without limitation unsaturated nitrile monomers, acrylic monomers, and the like, and combinations thereof.

Examples of the unsaturated nitrile monomers may include without limitation acrylonitrile, methacrylonitrile, ethacrylonitrile, and the like, and combinations thereof.

Examples of the acrylic monomer include without limitation methyl acrylate, methyl methacrylate and the like, and combinations thereof.

The rubber modified aromatic vinyl based graft copolymer (a1) can include the monomer copolymerizable with the aromatic vinyl monomer in an amount of about 1 to about 40% by weight based on the total weight (about 100% by weight) of the rubber modified aromatic vinyl based graft copolymer (a1). In some embodiments, the rubber modified aromatic vinyl based graft copolymer (a1) may include the monomer copolymerizable with the aromatic vinyl monomer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% by weight. Further, according to some embodiments of the present invention, the monomer copolymerizable with the aromatic vinyl monomer may be present in an amount of from about any of the foregoing amounts to about any other of the foregoing amounts.

The rubber modifier aromatic vinyl based graft copolymer (a1) may further include a monomer to impart processability and heat resistance. Examples of monomers imparting processability and heat resistance may include without limitation unsaturated carboxylic acids, unsaturated carboxylic anhydrides, maleimide monomers, and the like, and combinations thereof. Examples of the unsaturated carboxylic acid may include without limitation acrylic acid, methacrylic acid, and the like, and combinations thereof. Examples of the unsaturated carboxylic anhydride may include without limitation maleic anhydride. Examples of the maleimide monomer may include without limitation C₁-C₁₀ alkyl or phenyl N-substituted maleimides, and the like, and combinations thereof.

The rubber modified aromatic vinyl based graft copolymer (a1) can further include the monomer imparting processability and heat resistance in an amount of about 0 to about 15% by weight based on the total weight (about 100% by weight) of the rubber modified aromatic vinyl based graft copolymer (a1). In some embodiments, the rubber modified aromatic vinyl based graft copolymer (a1) may include the monomer imparting processability and heat resistance in an amount of 0 (the monomer imparting processability and heat resistance is not present), about 0 (the monomer imparting processability and heat resistance is present), 1, 2, 3, 4, 5, 6, 7, 8, 9, 10, 11, 12, 13, 14, or 15% by weight. Further, according to some embodiments of the present invention, the monomer imparting processability and heat resistance may be present in an amount of from about any of the foregoing amounts to about any other of the foregoing amounts.

The aromatic copolymer (A) may include the rubber modified aromatic vinyl based graft copolymer (a1) in an amount of about 10 to about 40% by weight, for example about 15 to about 40% by weight, and as another example about 15 to about 35% by weight, based on about 100% by weight of the aromatic copolymer (A) and the polycarbonate resin (B). In some embodiments, the aromatic copolymer (A) can include the rubber modified aromatic vinyl based graft copolymer (a1) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% by weight based on about 100% by weight of the aromatic copolymer (A) and the polycarbonate resin (B). Further, according to some embodiments of the present invention, the rubber modified aromatic vinyl based graft copolymer (a1) may be present in an amount of from about any of the foregoing amounts to about any other of the foregoing amounts.

(a2) Aromatic Vinyl Based Copolymer

The aromatic vinyl based copolymer (a2) can be prepared by copolymerizing an aromatic vinyl monomer, a monomer copolymerizable with the aromatic vinyl monomer, and optionally a monomer imparting processability and heat resistance. The aromatic vinyl based copolymer (a2) does not include a rubbery polymer, in contrast to the rubber modified aromatic vinyl based graft copolymer (a1).

The aromatic vinyl based copolymer (a2) can include about 60 to about 90% by weight of the aromatic vinyl monomer and about 10 to about 40% by weight of the monomer copolymerizable with the aromatic vinyl monomer, based on the total weight (about 100% by weight) of the aromatic vinyl based copolymer (a2).

In some embodiments, the aromatic vinyl based copolymer (a2) may include the aromatic vinyl monomer in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the aromatic vinyl monomer may be present in an amount of from about any of the foregoing amounts to about any other of the foregoing amounts.

In some embodiments, the aromatic vinyl based copolymer (a2) may include the monomer copolymerizable with the aromatic vinyl monomer in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% by weight. Further, according to some embodiments of the present invention, the monomer copolymerizable with the aromatic vinyl monomer may be present in an amount of from about any of the foregoing amounts to about any other of the foregoing amounts.

Examples of the aromatic vinyl monomer may include without limitation styrene monomers such as styrene, α-methyl styrene, β-methyl styrene, p-methyl styrene, p-(tert-butyl)styrene, ethylstyrene, monochlorostyrene, dichlorostyrene, dibromostyrene, vinylxylene, vinylnaphthalene, and the like, and combinations thereof.

One or more kind of monomers copolymerizable with the aromatic vinyl monomer may also be included. Examples of the monomer copolymerizable with the aromatic vinyl monomer may include without limitation unsaturated nitrile monomers, acrylic monomers, and the like, and combinations thereof.

Examples of the unsaturated nitrile monomers may include without limitation acrylonitrile, methacrylonitrile, ethacrylonitrile, and the like, and combinations thereof.

Examples of the acrylic monomer may include without limitation methyl acrylate, methyl methacrylate and the like, and combinations thereof.

The aromatic vinyl based copolymer (a2) may further include a monomer to impart processability and heat resistance. Examples of monomers imparting processability and heat resistance may include without limitation unsaturated carboxylic acids, unsaturated carboxylic anhydrides, maleimide monomers, and the like, and combinations thereof.

Examples of the unsaturated carboxylic acids may include without limitation acylic acid, methacrylic acid, and the like, and combinations thereof.

Examples of the unsaturated carboxylic anhydrides may include without limitation maleic anhydride.

Examples of the maleimide monomers may include without limitation C₁-C₁₀ alkyl or phenyl N-substituted maleimides, and the like, and combinations thereof.

The aromatic vinyl based copolymer (a2) may include a monomer imparting processability and heat resistance in an amount of about 0 to about 30% by weight based on the total weight (about 100% by weight) of the aromatic vinyl based copolymer (a2). In some embodiments, the aromatic vinyl based copolymer (a2) may include the monomer imparting processability and heat resistance in an amount of 0 (the monomer imparting processability and heat resistance is not present), about 0 (the monomer imparting processability and heat resistance is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the monomer imparting processability and heat resistance may be present in an amount of from about any of the foregoing amounts to about any other of the foregoing amounts.

The aromatic copolymer (A) can include the aromatic vinyl based copolymer (a2) in an amount of about 5 to about 85% by weight, for example about 5 to about 80% by weight, and as another example about 10 to about 80% by weight, based on about 100% by weight of the aromatic copolymer (A) and the polycarbonate resin (B). In some embodiments, the aromatic copolymer (A) can include the aromatic vinyl based copolymer (a2) in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, or 85% by weight based on about 100% by weight of the aromatic copolymer (A) and the polycarbonate resin (B). Further, according to some embodiments of the present invention, the aromatic vinyl based copolymer (a2) may be present in an amount of from about any of the foregoing amounts to about any other of the foregoing amounts.

(B) Polycarbonate Resin

A polycarbonate resin (B) of the present invention may be prepared by reacting one or more diphenols represented by Chemical Formula I with a phosgene, a halogen formate, a carbonic diester and combinations thereof

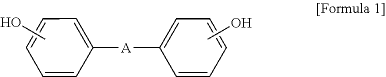

wherein A is a single bond, C₁ to C₅ alkylene, C₁ to C₅ alkylidene, C₅ to C₆ cycloalkylidene, —S— or —SO₂—.

Examples of diphenols of Chemical Formula I may include without limitation 4,4′-dihydroxy diphenyl, 2,2-bis-(4-hydroxyphenyl)-propane, 2,4-bis-(4-hydroxyphenyl)-2-methyl butane, 1,1-bis-(4-hydroxyphenyl)-cyclohexane, 2,2-bis-(3-chloro-4-hyroxyphenyl)-propane, 2,2-bis-(3,5-dichloro-4-hydroxyphenyl)-propane, and the like, and combinations thereof. In exemplary embodiments, the diphenol can include 2,2-bis-(4-hydroxyphenyl)-propane (also referred to as bisphenol-A or BPA), 2,2-bis-(3,5-dichloro-4-hydroxyphenyl)-propane, 1,1-bis-(4-hydroxyphenyl)-cyclohexane, and the like. In other exemplary embodiments, the diphenol can include 2,2-bis-(4-hydroxyphenyl)-propane.

The polycarbonate resin (B) according to the present invention may have a weight average molecular weight (Mw) of about 10,000 to about 200,000 g/mol, for example about 15,000 to about 80,000 g/mol.

In accordance with various embodiments of the invention, suitable polycarbonate resin (B) for use in the thermoplastic resin composition of the present invention may include without limitation linear polycarbonate resin, branched polycarbonate resin, polyester-carbonate resin, and the like, and combinations thereof. Suitable polycarbonate resin for use in the thermoplastic resin composition of the present invention may also include without limitation homopolycarbonate, copolycarbonate, and combinations thereof.

The polycarbonate resin (B) may be prepared using methods known in the art. For example, the polycarbonate resin may be a linear polycarbonate such as a bisphenol-A-based polycarbonate resin. As another example, branched polycarbonate resin can be prepared in a known manner, such as by incorporating about 0.05 to about 2 mol %, based on the total quantity of diphenols used, of tri- or higher functional compounds, for example, those with three or more phenolic groups. As yet another example, the polycarbonate resin may be totally or partially substituted with an ester precursor using known techniques, for example an aromatic polyester-carbonate resin prepared by polymerization in the presence of a difunctional carboxylic acid.

The thermoplastic resin composition may include the polycarbonate resin (B) in an amount of about 5 to about 55% by weight based on about 100% by weight of the aromatic copolymer (A) and the polycarbonate resin (B). In some embodiments, the thermoplastic resin composition can include the polycarbonate resin in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55% by weight. Further, according to some embodiments of the present invention, the polycarbonate resin may be present in an amount of from about any of the foregoing amounts to about any other of the foregoing amounts.

When the amount of the polycarbonate resin (B) is less than about 5% by weight, flame retardancy and impact strength of the thermoplastic resin composition may be deteriorated. On the other hand, when the amount of the polycarbonate resin (B) is more than about 55% by weight, flowability and thermal stability may be deteriorated.

(C) Halogen-Containing Compound

A halogen-containing compound of the present invention can be used as a flame retardant. Suitable halogen-containing compounds for use in the thermoplastic resin composition of the present invention may include bromine based compounds, chlorine based compounds, and the like, and combinations thereof.

Examples of the halogen-containing compound (C) suitable for preparing the thermoplastic resin composition may include without limitation decabromodiphenyl ethane, decabromodiphenyl ether, tetrabromobisphenol-A, tetrabromobisphenol-A epoxy oligomer, octabromotrimethylphenylindane, ethylene-bis-tetrabromophthalimide, tris(tribromophenol)triazine, brominated polystyrene, decabromodiphenyl oxide and the like and combinations thereof.

The halogen-containing compound may be melted at processing temperatures, for example, the halogen-containing compound may have a melting point or softening point of less than about 250° C.

The halogen-containing compound (C) may include more than about 50% by weight of halogen, for example about 50 to about 90% by weight of halogen. In some embodiments, the halogen-containing compound may include halogen in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, halogen may be present in an amount of from about any of the foregoing amounts to about any other of the foregoing amounts.

The thermoplastic resin composition may include the halogen-containing compound (C) in an amount of 1 to about 30 parts by weight based on about 100 parts by weight of the aromatic copolymer (A) and the polycarbonate resin (B). In some embodiments, the thermoplastic resin composition may include the halogen-containing compound (C) in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the halogen-containing compound may be present in an amount of from about any of the foregoing amounts to about any other of the foregoing amounts.

When the amount of the halogen-containing compound (C) is less than about 1 part by weight, flame retardancy of the thermoplastic resin composition may be deteriorated. On the other hand, when the amount of the halogen-containing compound (C) is more than 30 parts by weight, impact strength of the thermoplastic resin composition may be deteriorated.

(D) Antimony Compound

The thermoplastic resin composition of the present invention may include about 0 to about 2 parts by weight of an antimony compound (D) based on about 100 parts by weight of the aromatic copolymer (A) and the polycarbonate resin (B). In some embodiments, the thermoplastic resin composition may include the antimony compound (D) in an amount of 0 (the antimony compound (D) is not present), about 0 (the antimony compound is present), 1, or 2 parts by weight. Further, according to some embodiments of the present invention, the antimony compound may be present in an amount of from about any of the foregoing amounts to about any other of the foregoing amounts.

When the amount of the antimony compound is more than about 2 parts by weight, colorability and thermal stability of the thermoplastic resin composition may be deteriorated.

Examples of the antimony compound (D) suitable for preparing the thermoplastic resin composition may include without limitation antimony trioxide, antimony pentaoxide, and the like, and combinations thereof.

(E) Additive(s)

The thermoplastic resin composition may optionally include one or more additives, depending on the use of each and additional desired properties for the thermoplastic resin composition. Examples of such additives may include without limitation impact modifiers, anti-dripping agents, antioxidants, plasticizers, heat stabilizers, light stabilizers, compatibilizers, weather resistant agents, dyes, pigments, coloring agents, inorganic fillers, and the like, and combinations thereof.

The additive (E) can be used in an amount of less than about 30 parts by weight, for example about 0.0001 to about 30 parts by weight, based on about 100 parts by weight of the aromatic copolymer (A) and the polycarbonate resin (B).

The thermoplastic resin composition according to the present invention can be prepared by a conventional method. For example, the components and optional additives can be mixed together and extruded through an extruder and can be prepared in the form of pellets or chips.

The thermoplastic resin composition of the present invention may have a flame retardancy measured in accordance with UL 94 using a specimen with a thickness of 1.5 mm of about V0.

The thermoplastic resin composition of the present invention may have a value of L measured in accordance with ASTM D1925 using a spectrophotometer of about 26 to about 27.

The thermoplastic resin composition of the present invention may have a number of burst marks for out-gas of about 0 to 5 when subjected to injection molding conditions, for example a cylinder temperature of about 250° C. and a residence time of about 10 minutes, as for 10 injection molded specimens. The thermoplastic resin composition of the present invention can have excellent flame retardancy, colorability and thermal stability and can be used in the production of various products including without limitation housings for electric and electronic goods such as TVs, audio devices, cellular phones, digital cameras, navigation systems, washing machines, computers, monitors, MP3 players, video players, CD players, and the like, as well as large-sized molded products.

A plastic molded article of the present invention is prepared by the thermoplastic resin composition of the present invention. Methods for preparing the plastic molded articles using the thermoplastic resin composition of the present invention are not limited, and methods such as extrusion, injection, blow, compression molding or casting may be employed. Such methods are known in the art and be readily conducted by those skilled in the art.

The invention may be better understood by reference to the following examples which are intended for the purpose of illustration and are not to be construed as in any way limiting the scope of the present invention, which is defined in the claims appended hereto.

### EXAMPLES

The specifications of each component in the following examples and comparative examples are as given below.

(A) Aromatic Copolymer

(a1) Rubber Modified Aromatic Vinyl Based Graft Copolymer

A grafted-acrylonitrile-butadiene-styrene copolymer (g-ABS) having about 58% by weight of polybutadiene rubber made by Cheil Industries, Inc. of Republic of Korea is used.

(a2) Aromatic Vinyl Based Copolymer

A styrene-acrylonitrile copolymer (SAN) having about 28% by weight of acrylonitrile made by Cheil Industries, Inc. of Republic of Korea is used.

(B) Polycarbonate Resin

A bisphenol-A type polycarbonate resin made by Teijin Company of Japan (product name: PANLITE L-1250) is used.

(C) Halogen-Containing Compound

A halogen-containing compound made by Albemarle Company of U.S.A. (product name: Saytex 4010) is used.

(C′) Phosphorus-Containing Compound

A bisphenol-A diphosphate made by Daihachi Chemical Company of Japan (product name: CR-741) is used.

(D) Antimony Compound

An antimony compound made by Ilsung Antimony Company of Republic of Korea (Product name: ANTIS-W) is used.

Physical properties are measured by the following method:

(1) Flame retardancy: The flame retardancy is measured in accordance with UL 94 using a specimen with a thickness of 1.5 mm.

Fail: total burning time is more than 50 seconds or each of burning time is more than 10 seconds

(2) Colorability: A value of L is measured in accordance with ASTM D1925 using a CM-3600D spectrophotometer of Konica Minolta Company.

(3) Thermal stability: A number of burst marks for out-gas is measured during injection molding at a cylinder temperature of 250° C. and a residence time of 10 minutes, as for 10 injection molded specimens.

Good: no burst mark for out-gas, Normal: small number of burst marks for out-gas are generated (less than about 5), Bad: large number of burst marks for out-gas are generated (more than about 5)

(4) Flowability (spiral flow length, mm): A spiral flow length is measured by 20 oz injection molding machine under a cylinder temperature of 220° C. and a mold temperature of 60° C. using a metallic mold having a helical form cavity with dimensions of 5 mm×0.5 mm. The spiral flow length is determined as a length of molded product.

Preparing of Thermoplastic Resin Composition

Compositions including the components in amounts shown in the following Tables 1 and 2, 0.5 parts by weight of carbon black, 1.5 parts by weight of antioxidants, and 1.0 part by weight of heat stabilizers are extruded through a conventional extruder and pellets are prepared using a twin screw extruder (L/D=35, φ=45 mm). The prepared pellets are injection molded to form specimens using a 15 oz injection molding machine under conditions of a molding temperature of 220 to 240° C. After drying the specimens at a temperature of 23° C. and relative humidity of 50% for 2 hours, samples are prepared.

In the following Tables 1 and 2, the amounts of (a1), (a2) and (B) are based on 100% by weight of (a1), (a2) and (B), and the amounts of (C), (C′) and (D) are based on 100 parts by weight of (a1), (a2) and (B).

TABLE 1

| | | Examples | | | | |
|---|---|---|---|---|---|---|
| | | 1 | 2 | 3 | 4 | 5 |
| (A) | (a1) | 30 | 30 | 30 | 30 | 30 |
| | (a2) | 55 | 45 | 35 | 20 | 60 |

| | | | | | |
|---|---|---|---|---|---|
| (B) | 15 | 25 | 35 | 50 | 10 |
| (C) | 20 | 20 | 20 | 20 | 20 |
| (C′) | — | — | — | — | — |
| (D) | — | — | — | — | 1 |
| Flame retardancy | V0 | V0 | V0 | V0 | V0 |
| Colorability | 26 | 26.5 | 26.5 | 26.5 | 27 |
| Thermal stability | Good | Good | Good | Good | Normal |
| Flowability | 320 | 312 | 301 | 277 | 323 |

TABLE 2

| | | Comparative Examples | | | | | | |
|---|---|---|---|---|---|---|---|---|
| | | 1 | 2 | 3 | 4 | 5 | 6 | 7 |
| (A) | (a1) | 30 | 30 | 30 | 30 | 30 | 30 | 30 |
| | (a2) | 10 | 67 | 70 | 70 | 70 | 45 | 45 |

| | | | | | | | |
|---|---|---|---|---|---|---|---|
| (B) | 60 | 3 | — | — | — | 25 | 25 |
| (C) | 20 | 20 | 20 | 20 | 20 | 20 | — |
| (C′) | — | — | — | — | — | — | 20 |
| (D) | — | — | 1 | 5 | 3 | 5 | — |
| Flame retardancy | V0 | fail | fail | V0 | V1 | V0 | Fail |
| Colorability | 25.3 | 26.5 | 27 | 29 | 28.2 | 29.5 | 26.5 |
| Thermal stability | Good | Good | Normal | Bad | Normal | Bad | Good |
| Flowability | 220 | 335 | 351 | 348 | 345 | 310 | 250 |

As shown in Tables 1 and 2, in Comparative Example 1 which includes polycarbonate resin in an amount outside of the range of the present invention, the flowability is deteriorated. Also, in Comparative Example 2 which includes polycarbonate resin in an amount outside of the range of the present invention, flame retardancy is deteriorated. In Comparative Example 4 which uses an antimony compound without polycarbonate resin, the colorability and the thermal stability are deteriorated. In Comparative Example 3 which uses a smaller amount of an antimony compound than Comparative Example 4, the flame retardancy is deteriorated. In Comparative Example 5, the colorability and the thermal stability are deteriorated. In Comparative Example 6 which uses an antimony compound in an amount outside of the range of the present invention, the colorability and the thermal stability are deteriorated. In Comparative Example 7 which uses a phosphorus-containing compound instead of a halogen-containing compound, the flame retardancy and flowability are deteriorated.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A thermoplastic resin composition comprising:
(A) about 45 to about 95% by weight of an aromatic copolymer;
(B) about 5 to about 55% by weight of a polycarbonate resin;
(C) about 1 to about 30 parts by weight of a halogen-containing compound based on about 100 parts by weight of the aromatic copolymer (A) and the polycarbonate resin (B); and
(D) about 0 to about 2 parts by weight of an antimony compound based on about 100 parts by weight of the aromatic copolymer (A) and the polycarbonate resin (B).

2. The thermoplastic resin composition of claim 1, wherein the aromatic copolymer (A) comprises (a1) a rubber modified aromatic vinyl based graft copolymer and (a2) an aromatic vinyl based copolymer, wherein the aromatic copolymer (A) comprises about 10 to about 40% by weight of the rubber modified aromatic vinyl based graft copolymer (a1) based on about 100% by weight of the aromatic copolymer (A) and the polycarbonate resin (B) and about 5 to about 85% by weight of the aromatic vinyl based copolymer (a2) based on about 100% by weight of the aromatic copolymer (A) and the polycarbonate resin (B).

3. The thermoplastic resin composition of claim 2, wherein the rubber modified aromatic vinyl based graft copolymer (a1) comprises about 5 to about 65% by weight of a rubbery polymer, about 20 to about 94% by weight of an aromatic vinyl monomer, and about 1 to about 40% by weight of a monomer copolymerizable with the aromatic vinyl monomer.

4. The thermoplastic resin composition of claim 3, wherein the rubbery polymer comprises a diene rubber, a saturated rubber in which hydrogen is added to a diene rubber, an acrylic rubber, an ethylene-propylene rubber, an ethylene-propylene-diene terpolymer (EPDM), a silicone rubber, or a combination thereof.

5. The thermoplastic resin composition of claim 3, wherein the aromatic vinyl monomer comprises styrene, α-methyl styrene, β-methyl styrene, p-methyl styrene, p-(tert-butyl)styrene, ethylstyrene, vinylxylene, monochlorostyrene, dichlorostyrene, dibromostyrene, vinylnaphthalene, or a combination thereof.

6. The thermoplastic resin composition of claim 3, wherein the monomer copolymerizable with the aromatic vinyl monomer comprises an unsaturated nitrile monomer, an acrylic monomer, or a combination thereof.

7. The thermoplastic resin composition of claim 2, wherein the aromatic vinyl based copolymer (a2) comprises about 60 to about 90% by weight of an aromatic vinyl monomer, and about 10 to about 40% by weight of a monomer copolymerizable with the aromatic vinyl monomer.

8. The thermoplastic resin composition of claim 7, the aromatic vinyl monomer comprises styrene, α-methyl styrene, β-methyl styrene, p-methyl styrene, p-(tert-butyl)styrene, ethylstyrene, vinylxylene, monochlorostyrene, dichlorostyrene, dibromostyrene, vinylnaphthalene, or a combination thereof.

9. The thermoplastic resin composition of claim 7, wherein the monomer copolymerizable with the aromatic vinyl monomer comprises an unsaturated nitrile monomer, an acrylic monomer, or a combination thereof.

10. The thermoplastic resin composition of claim 2, wherein the aromatic vinyl based copolymer (a2) further comprises about 0 to about 30% by weight of a monomer comprising an unsaturated carboxylic acid, an unsaturated carboxylic anhydride, a maleimide monomer, or a combination thereof, based on about 100% by weight of the aromatic vinyl based copolymer (a2).

11. The thermoplastic resin composition of claim 1, the polycarbonate resin (B) has a weight average molecular weight (Mw) of about 10,000 to about 200,000 g/mol.

12. The thermoplastic resin composition of claim 1, the polycarbonate resin (B) is bisphenol-A based polycarbonate.

13. The thermoplastic resin composition of claim 1, wherein the halogen-containing compound (C) comprises decabromodiphenyl ethane, decabromodiphenyl ether, tetrabromobisphenol-A, tetrabromobisphenol-A epoxy oligomer, octabromotrimethylphenylindane, ethylene-bis-tetrabromophthalimide, tris(tribromophenol)triazine, brominated polystyrene, decabromodiphenyl oxide, or a combination thereof.

14. The thermoplastic resin composition of claim 1, wherein the halogen-containing compound (C) comprises about 50 to about 90% by weight of halogen.

15. The thermoplastic resin composition of claim 1, wherein the antimony compound (D) comprises an antimony trioxide, an antimony pentaoxide, or a combination thereof.

16. The thermoplastic resin composition of claim 1, wherein the thermoplastic resin composition further comprises an additive comprising an impact modifier, an anti-dripping agent, an antioxidant, a plasticizer, a heat stabilizer, a light stabilizer, a compatibilizer, a weather resistant agent, a dye, a pigment, a coloring agent, an inorganic filler, or a combination thereof.

17. The thermoplastic resin composition of claim 1, having a flame retardancy measured in accordance with UL 94 using a specimen with a thickness of 1.5 mm of about V0.

18. The thermoplastic resin composition of claim 1, having a value of L measured in accordance with ASTM D1925 using a spectrophotometer of about 26 to about 27.

19. The thermoplastic resin composition of claim 1, having a number of burst marks for out-gas of about 0 to 5 measured at an cylinder temperature of about 250° C. and a residence time of about 10 minutes, as for 10 injection molded specimens.

20. A plastic molded article is prepared by the thermoplastic resin of claim 1.
